(19) United States
(12) Patent Application Publication
(10) Pub. No.: US 2018/0144390 A1
(43) Pub. Date: May 24, 2018

(54) SYSTEM AND METHOD FOR QUANTIFYING THE EXPERIENCE OF CANNABIS USAGE

(71) Applicant: Immanuel Constantin BECKFORD, Toronto (CA)

(72) Inventor: Immanuel Constantin BECKFORD, Toronto (CA)

(21) Appl. No.: 15/821,798

(22) Filed: Nov. 23, 2017

Related U.S. Application Data
(60) Provisional application No. 62/426,286, filed on Nov. 24, 2016.

(51) Int. Cl. G06Q 30/06; G06Q 30/02

(52) U.S. Cl. CPC G06Q 30/0631; G06Q 30/01; G06Q 30/0633; G06Q 30/0282

(57) ABSTRACT

A system and method for acquiring feedback information in relation to cannabis and THC containing products. The review platform contained within the invention operates around a series of controlled inputs. Information pertaining to items purchased is inputted into the system by an authorized user that is not the reviewer. The invention provides users with a system that tracks and logs purchases, and allows the user to input feedback information pertaining to items that they have purchased. The system acquires feedback information through a series of navigation pages contained within a controlled input review platform. The information is used to create specialized feedback reports, and the reports are sent to retailers, vendors, manufactures, consumers, and domain experts.

### FIELD OF THE INVENTION

The present invention is a system and method for quantifying user experience of cannabis usage.

### BACKGROUND OF THE INVENTION

Cannabis contains the psychoactive chemical delta-9-tetrahydro-cannabinol (THC), which has both medicinal and recreational use. Due to various types of strains of cannabis available in the market, it is difficult for a consumer to keep track of every strain of purchased and consumed cannabis.

Currently, there are a very few systems and methods for consumers to provide product feedback information pertaining to cannabis or THC containing products that are purchased from authorized/licensed cannabis clinics or retail stores. These methods provide a templated text base review platforms with pre-set selections for the reviewer to choose from. The information acquired using the standard text based review format only collect a small fraction of information that is available by a user.

Another problem associated with the current methods is that they rely on the consumer to select and chose the strains that has been consumed. They do not implement any sort of secured entry for the user. Users are left to select the strains that they have tried freely and can input reviews on any strain that is listed on the site. Allowing consumers to select the products they have tried for review can be problematic because the reviewer can make a mistake about the product they have consumed. These systems do not have a strain logging system, and have no control on the user entry, which leaves the input of the strain consumed entirely up to the consumer.

Another problem associated with the currently available methods is that they use a text-based review to acquire information. Methods that use plain text to acquire information can be problematic to the reviewer and the reader, since it is entirely up to the reviewer to decide what should be included in the review. Systems that do not provide a template for consumer to provide reviews, require that the consumer use his discretion when deciding what information to and not to disclose in the review. This can limit the information that may be available to the readers and result in an inaccurate or incomplete reviews.

Systems that allow users to input information freely are ineffective because it allows user to input information about the strain regardless of whether they actually tried it or not. When a user is left to select the strains for review, mistakes on the strain can be made. Multiple manufactures grow the same strains but that does not mean it is the same product. Systems that require the user to select the products they have consumed, can be problematic because of the nature of this complicated product.

When cannabis is consumed for recreational purposes, effects such as increase in the heart rate, reduction in the blood pressure, more rapid breathing and other effects are possible. Nowadays consumers refer to social websites to learn more about the products and obtain information from reviews left by the other consumers. Therefore, there is a need for a system and method that the user can leave a feedback at his/her own discretion about important effects of a product consumed.

### SUMMARY OF THE INVENTION

The present invention is a computer system and a method for acquiring feedback information and generating recommendation in relation to cannabis and THC containing products. This system allows a controlled exchange of information between users.

Each consumer that needs to use the system, creates an account on the system. Legalized cannabis stores, who have registered on the system will also have access to the consumer account. They are referred to as authorized users. Each consumer account has a purchase log. The purchase log is updated by the authorized user and contains purchase log data and information pertaining to the purchase that the consumer made from the authorized cannabis stores. The purchase log collects the information about the retail store and its location, and is automatically tagged to the purchase information that is updated into the users account. The purchase log data is also logged into a recommendation engine.

Currently there are very few systems and methods for consumers that aid and assist the purchasing process by providing product recommendations for cannabis products. The recommendation systems that are currently available in the industry have limited capabilities because they are designed to tailor to a medicinal market, and does not offer support for recreational users. Therefore, there is a need in the industry for a system or method that can provide recommendations to recreational and medicinal users.

Another issue that exists in the industry is that there are currently no systems available that are designed to aid and assist a budtender, with sales orders, by providing information based on the consumer's prior experiences with cannabis products. Consumers engaging with a budtender during a purchase order often require assistance while deciding their product selection. For a bud tender to serve a consumer accurately the budtender will require information from the consumer pertaining to the consumers consumption history and the experience acquired while consuming the products. The process of acquiring the information the budtender requires to assist the consumer, through verbal communication causes a delay in the purchases process, budtenders are required to spend more time assisting consumers based on their personal needs. Therefore, there is currently a need in the industry, for a system that can help automate the process of acquiring information related to consumers consumption habits and experiences, for the purpose of providing the budtender with information to aid and assist consumers in the product selection process.

Once the purchase log is updated by the authorized user, the consumer will be able to view the information that is updated into his/her account and proceed with the system. One important aspect of the present system is that the purchase log is updated by the authorized user and not by the consumer. This assures that the information on the cannabis product are those provided by the vendor and not by the consumer, which can be incorrect.

Each vendor stores a store-product catalogue on the system, which is accessible to the consumer through the purchase log. The system provides two methods that can be used to log the purchase information into the consumer's account. The first method allows authorized users using the system to manually log the product information into the consumer's account. This method requires the authorized user to manually select products from the catalogued inventory and input the amount purchased into the system.

The second method for logging purchase information is through an implementation of an API call or an EPOS adapter. The system is built to integrate with various types of POS systems. If the legalized cannabis store where the system is housed has a compatible POS system, the system can use an API call or EPOS adapter to import information pertaining to the consumers purchase. This method allows the authorized user to avoid the extra step of manually logging purchase information into two separate systems. The method allows for information to be logged into one system (the POS) and ported over to the other system.

Consumers purchasing through an online store can utilize the systems process for controlled purchase information logging, by providing the account number or information associated with their account during the checkout process. This will allow the online cannabis store to update the information into the users purchase log while the order is being filled and processed.

The system also contains a review platform for consumers. The review platform allows the consumer to input additional information on the product after it is consumed. The review platform is made available for products that appear in the purchase log and remains active only for a period of time or after a certain number of reviews. The consumer provides feedback only on the products that is purchased and used.

The system implements a controlled input review platform that consists of at least six various sections. These sections comprise of a method of consumption section, a potency gauger section, a product irritant section, a user experience section, a “product review survey, comparison, and rating” section, and a prolonged user experience section.

The system of acquiring feedback information pertaining to cannabis usage preferably requires very little or no plain text entry by the user. A series of templates and selections are designed and are pre-set into the system. The user is prompted to provide reviews through a selection of pre-set choices.

The system uses the information that is collected through purchase log and the review platform to create several different system generated reports for different purposes. The reports that are created by the system are reported out through a series of in-system reporting channels to consumers, the retailers, the manufacturers, the vendors, and the domain experts. The reports are send out via a mobile application or web based application.

The consumer-reports are personalized reports using a collaborative filtering algorithm. The consumer-reports provide information on products that best matched the consumer's feedback. The collaborative filtering algorithm matches consumers with similar feedbacks and recommends products and items that similar users have rated highly. The information on this report is also used to make product recommendation to a consumer.

Consumer can utilize the purchase log, the review platform, and the reporting channel features on the system after signing into the system. The system keeps an organized log of all the cannabis pertaining products that is purchased from different authorized cannabis stores by the consumer. The purchases appear in the purchase log in the consumers account after the information is updated into the account.

Consumer can also utilize the review platform and input additional information pertaining to the usage of the products that appear in the consumers purchase log.

The retail system contains a unique feature that allows budtenders to view similar reports to what the consumer receives. This is provided after the consumer's account information is entered into the system. This allows for the budtender obtaining personalized information about each individual consumer and better assisting the consumer with orders.

Manufacturers and vendors are also able to utilize the system's report channel feature contained within the invention. Vendors have access to reports via an in-system report channel that is accessible via the system's web based application. Information compiled by the system through the review platform and the purchase logging method are used by the system to create specified reports for the vendors.

The system also generates reports for the manufactures. These reports are created using the information that is compiled by the system. These reports generally pertain to product performance reports, and mainly comprise summaries of various feedback information that is acquired from the user while using the review platform.

The system also generates reports for vendors and is capable of connecting vendors to retailers based of the information that is acquired through the review platform. The recommendations or reports that vendor receives are made available through a reporting channel and are accessible via the web based application.

The domain experts can also utilize the system's report channel feature contained within the invention. The domain experts have access to reports via an in-system report channel that is accessible via the system's web based application. Information compiled by the system through the review platform and the purchase logging method are used by the system to create specified reports for the domain experts.

It is therefore an object of the present invention to provide a method and system for quantifying the experience of cannabis users to track and log the strains that they consume.

It is another object of the present invention to provide feedback and quantify the experience of the consumers only on products they used.

It is another object of the present invention to implement a controlled entry strain logging system that allows consumer to keep track of the products they purchased.

It is another object of the present invention to provide a controlled entry system, so that information pertaining to the purchased product can only be updated into the customer's account by an authorized user using the system stationed at an authorized location.

It is another object of the present invention to provide a system which uses the feedbacks inputted by the consumer to create personalized reports and make recommendations that assists the consumer with future purchases.

It is another object of the present invention to enable the consumers to keep an organized log of all the strains and products purchased from various stores that house the system.

It is another object of the present invention to implement a controlled entry review platform that provides the user with a series of pre-set selections to choose from.

It is another object of the present invention to provide a method and system which is beneficial for both new and experienced consumers.

It is another object of the present invention to use graphic representations to make the process of providing reviews more intimate and user friendly.

It is another object of the present invention to provide feedback information to various authorized users of the system including consumers, retailers, manufacturers, vendors, and domain experts.

It is another object of the present invention to aggregate experience data across user types and consumption method for collaborative recommendations.

Other objects, features, and advantages of the present invention will be readily appreciated from the following description. The description makes reference to the accompanying drawings, which are provided for illustration of the preferred embodiment. However, such embodiments do not represent the full scope of the invention.

### BRIEF DESCRIPTION OF THE DRAWINGS

Embodiments herein will hereinafter be described in conjunction with the appended drawings provided to illustrate and not to limit the scope of the claims, wherein like designations denote like elements, and in which;

FIG. 1 is a diagram of the customer feedback system of the present invention;

FIG. 2 is a diagram of the customer feedback system of the present invention;

FIG. 3 is a diagram of the customer feedback system of the present invention

FIG. 4 illustrates a method of selection of consumption, according to the present invention;

FIG. 5 illustrates a method of gauging the potency effect of the product;

FIG. 6 illustrates the method to obtain the feedback of the user about the irritants of the product;

FIG. 7 illustrates the method to obtain the user experience according to the present invention;

FIG. 8 illustrates the process of survey review and the rating section of the review platform;

FIG. 9 illustrates another prolonged customer survey section according to the invention;

FIG. 10 illustrates the system of the review platform of the present invention;

FIG. 11 illustrates the system of the review platform of the present invention; and

FIG. 12 illustrates the system of the review platform of the present invention.

### DETAILED DESCRIPTION OF THE DRAWINGS

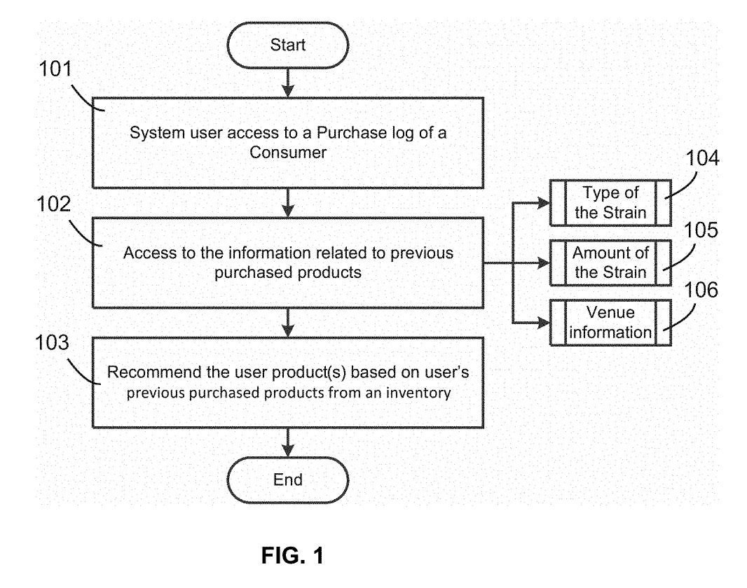

FIGS. 1, 2 and 3 illustrate the feedback system according to the present invention. According to FIG. 1 a consumer logs in his or her account to enable an authorized user 101 to have access to said account by using one of the available methods associated with the consumers account. An authorized user using the system is a dispensary, a vendor or any other cannabis store. The authorized user is then capable to access to the previous information of the consumer stored in the purchase-log of the system and make updates to the account 102. The information contains information about the type of the product 104, amount of the product 105 and information about the cannabis stores 106. The system recommends the user product(s) based on users previous purchased products from an inventory which exist in the system 103.

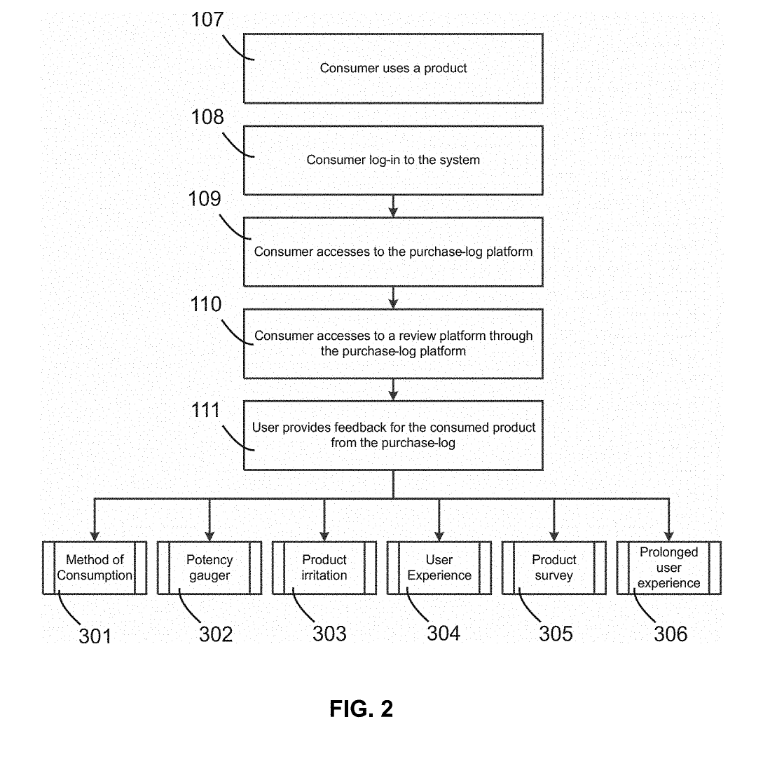

Referring to FIG. 2 the consumer selects and uses the product 107 from the items offered by the catalogued inventories in the system or selects the product from the recommended items by the system from the information in purchase log.

The system provides two methods that can be used to log the purchase information into the consumer's account. The first method allows authorized users using the system to manually log the product information into the consumer's account. This method requires the authorized user to manually select products from the catalogued inventory and input the amount purchased into the system. The second method for logging purchase information is through an implementation of an API call or an EPOS adapter. The system will be built to integrate with various types of POS systems. If the cannabis stores where the system is housed has a compatible POS system, the system can use an API call or EPOS adapter to import information pertaining to the consumers purchase. Also the user proceeds to provide feedback in-relation to the items purchased.

Consumer's log-in to the system 108 to access to the purchase-log platform of the system 109. After the information has been successfully ported into the user's account, the consumer will proceed to the review platform to provide feedback about the product 110.

The system provides a review platform with a series of product feedback navigation page. The consumer uses the product and logs in to the review platform by the consumers log in account. The authorized user permit the consumer to input feedback on purchased items from the purchase log.

The consumer starts to enter the navigation pages in review platform and input feedback about the consumed items 111. The review platform that the system uses is comprised of six sections: a method of consumption section 301, a potency gauger section 302, a product irritants section 303, a user experience section 304, a product review comparison and rating section 305 and a prolonged user experience section 306.

While providing a review the consumer will be prompted to complete 5 first sections 301, 302, 303, 304, 305 and will have the option to complete a sixth 306 after the initial 5 are completed. The first 5 sections of the review platform are mandatory for the completion of a review. After the user has completed the initial review a sixth section 306 will be made available to the user after a period of time has elapsed, this section 306 will pertain to prolonged user experience.

The system includes reporting channels for consumers, retailers, vendors, manufactures, and domain experts. The reports received by the different reporting channels will be system generated. The reports that the system generates will vary widely across different user types.

The use of these navigation pages are essential for the systems reporting feature, each navigation page is used to establish the parameters for the data source that the consumer will use to provide information. The use of the navigation pages allows the system to acquire specified data points in the information for filtering purposes, the navigation pages groups' information to make it easier for the system to filter across. The main filters that will be utilized for consumer reporting will be; filter by method of consumption, filter by potency, filter by irritants, filter by effect, and filter by survey.

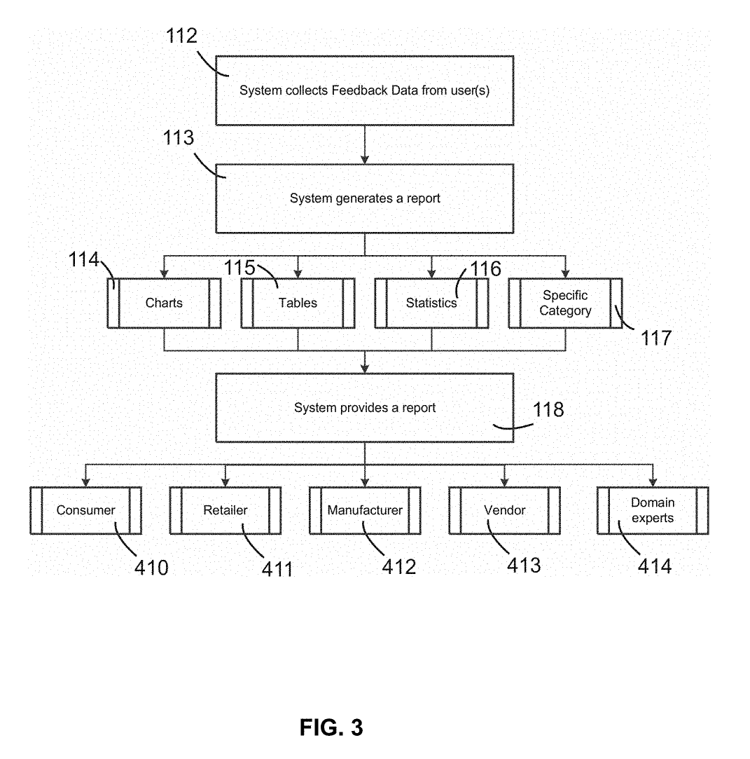

FIG. 3 shows how the feedback information complies across users from the raw survey responses. The system anonymizes and collects the responses to each question, and creates benchmarks to compare results 112. The system uses a tracking method to collect information for specific users.

The system uses the information to create reports 113, these reports can include but are not limited to charts 114, data tables 115, basic statistics 116 and specific categories 117. Reports are received on an in-system reporting channels.

The system generates specific reports for the specific sources 118 and is provided to the in system channels including the consumers 410, the retailers 411, the manufactures 412, the vendors 413, and domain experts 414.

The system generates reports for consumers using a collaborative filtering algorithm. The system is capable of making predictions pertaining to products which the user may be interested in trying by implementing a collaborative filtering algorithm. Collaborative filtering algorithms require users' active participation, an easy method to represent users' interests, and algorithms that are able to match people with similar interests.

The system implement navigations pages to create filters for information grouping. The system further matches user's ratings against other users' and finds the people with most “similar” tastes. The system recommends items that the similar users have rated highly but not yet being rated by this user (presumably the absence of rating is often considered as the unfamiliarity of an item). The use of filters is essential to the system to identify different user types within the data, the system will use exclusion passes to identify indifferences to exclude in the filtering quire (i.e. filter by method of consumption, for example a water pipe user excludes all user types that is not a water pipe).

The personalized reports that the system generates for the consumer will also be accessible by the retailer. The retailer will be capable of viewing the system made predictions after of being giving access to the consumers account in an order assist feature contained within the system. The order assist feature will be a series of reports that the system has generated for the user as well as the user prior purchase log containing the user previous purchases and the general ranking or rating the system has assigned to the product based of the information inputted by the user or (a representation of the user's preference).

The system creates reports for retailers, vendors, and manufactures. The reports that are created for these user types will be product performance reports. The system will acquire information pertaining to specified products sold in store using the product purchase log, by user completed reviews. The information acquired for specified products will be grouped across users using same product. The information will be used to create statistical and analytical representations of the products performance. Reports will be generated by the system pertaining to the products performance, and sent to the users that the product pertains to. The store from where it is sold (retailer) the local supplier (vendor) and the grower (manufacture).

The system will use the product performance reports generated by the system, and implement a business logic filter to create system generated recommendations for retailers. The recommendations made by the system determine how certain actions may affect a retailer's business. For example, it is not useful to restock an item that did poorly with majority users. The system may suggest that the retailer avoid the repurchase of said product, on the prediction that it may not sell as well with stores repeat customers.

The system generates specialized reports for the domain experts by additional filters, cluster analysis and the information generated by the system. Specialized reports will use large data clusters to draw information from, the information contained within these data cluster from all other users across the system. Users information will be anonymized for the creation of specialized reports, because the information will be assigned into a group or cluster, for statistical or analytical purposes. The specialized reports created by the system will pertain to behavioral patterns across users. The system will implement a series of additional filters (algorithms) in order to find data points in information clusters. These data points will be used to track behavioral or personality patterns across information group clusters.

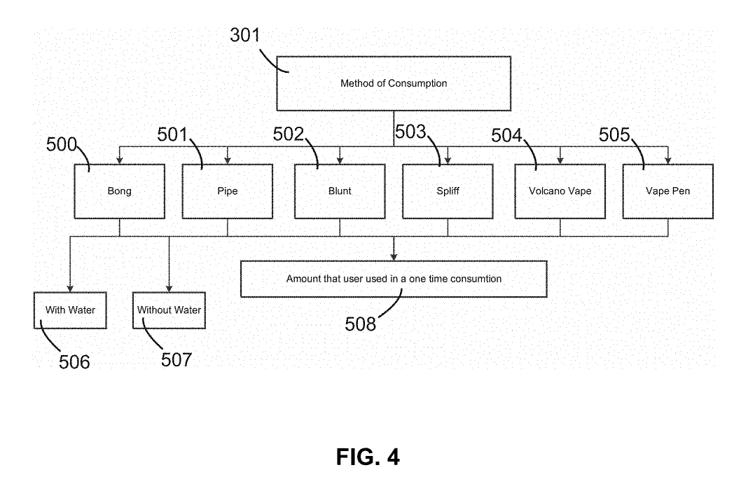

FIG. 4 illustrates of the process that the user may undergo while in the method of consumption section 301 of the review platform. In this section, the consumer will have the ability to select a method of consumption from a list of pre-set methods comprising: a bong 500; a pipe 501; a blunt 502; a splift (joint, marijuana cigarette) 503, a volcano vape 504 or a vape pen 505.

The system will provide the consumer with the ability to input additional information pertaining to the method of consumption 506 and 507 and the amount of the consumed product 508.

After the user has completed inputting information pertaining to the method of consumption, they may proceed to continue to the next section of the review platform.

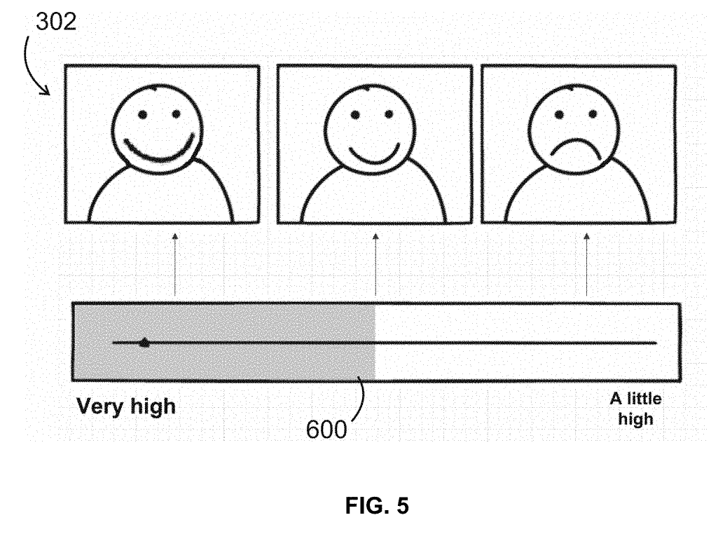

FIG. 5 illustrates the method of gauging the potency effect of the product. In this process the user may experience potency gauger section 302 of the review platform.

The consumer will be presented with some sort of slider or gauge 600; the slider or gauge will contain an array of color that corresponds to potency level on the slider or gauge and contain descriptive words (very high to a little high) to help the consumer scale or gauge the potency effect more accurately.

The user will also be presented with some sort of graphic representation that can used to visually show changes to the potency level as they are made on the gauge or slider. As the potency level is adjusted on the slider or gauge, the feature contained within the graphic representation such as the eyes, and mouth will also change to reflect an increase or decrease in potency. As the user adjusts the slider or gauge, the eyes contained within the graphic representation will change slightly in color, and shape, to reflect the blood vessels in the eyes constricting when cannabis is consumed. As the user adjusts the slider or gauge the mouth contained within the graphic representation will change slightly in shape to reflect the initial effects of cannabis taking effect on the user 100. After the user has gauging the potency effect of the product, they may proceed to continue to the next section of the review platform.

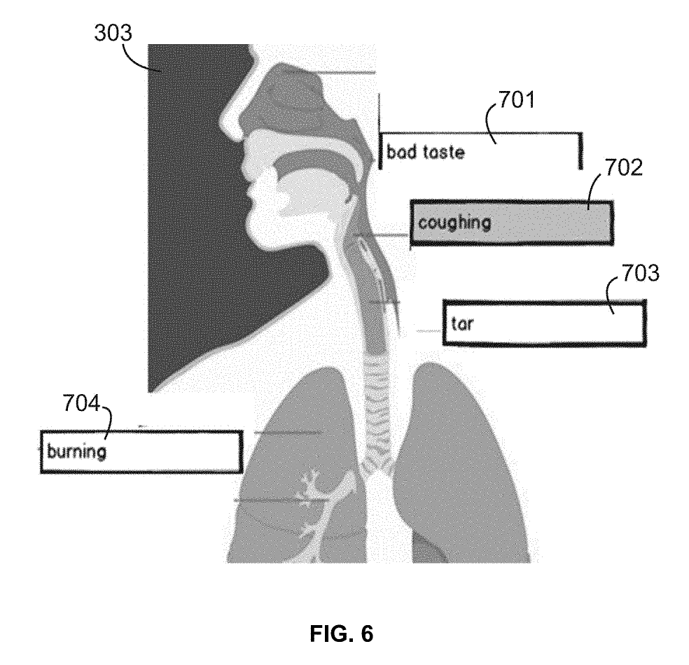

FIG. 6 the consumer undergoing the product irritant section 303 of the review platform. The consumer will be presented with some sort of graphic representation containing a diagram of the respiratory system. The consumer will have the ability to input irritants that he/she experienced while consuming the product from a pre-set selection of irritants. Depending on the type of irritant selected by the user (bad taste 701, coughing 702, tar 703 and burning 704) the system may place an irritant tag on the diagram atomically, or have the user manually place an irritant tag on the diagram, and then gauge the level and range of the irritant. After the user has completed inputting information pertaining to product irritants, they may proceed to continue to the next section of the review platform.

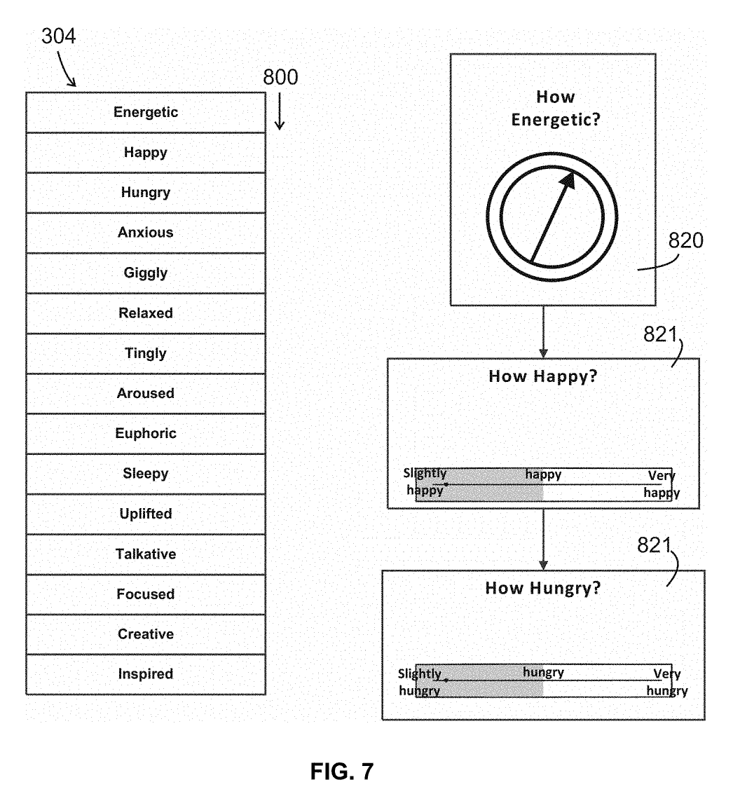

According to FIG. 7 the method contains a process that the user may undergo in the user experience section 304 of the review platform. In this section 304 the consumer will be prompted to input information pertaining to the product effects that the user is experiencing. The user will have the ability to select from a pre-set list of descriptive words, containing various effects that are associated with the product. The pre-set list contains: energetic, happy, hungry, anxious, giggly, relaxed, tingly, aroused, euphoric, sleepy, uplifted, talkative, focused, creative and inspired 800.

After the user has finished selecting all the corresponding effects from the pre-set list 800 the system will ask the consumer to range the effects selected with a gauge 820 or a slider 821. After the user has completed inputting information pertaining to user experience, they may proceed to continue to the next section of the review platform.

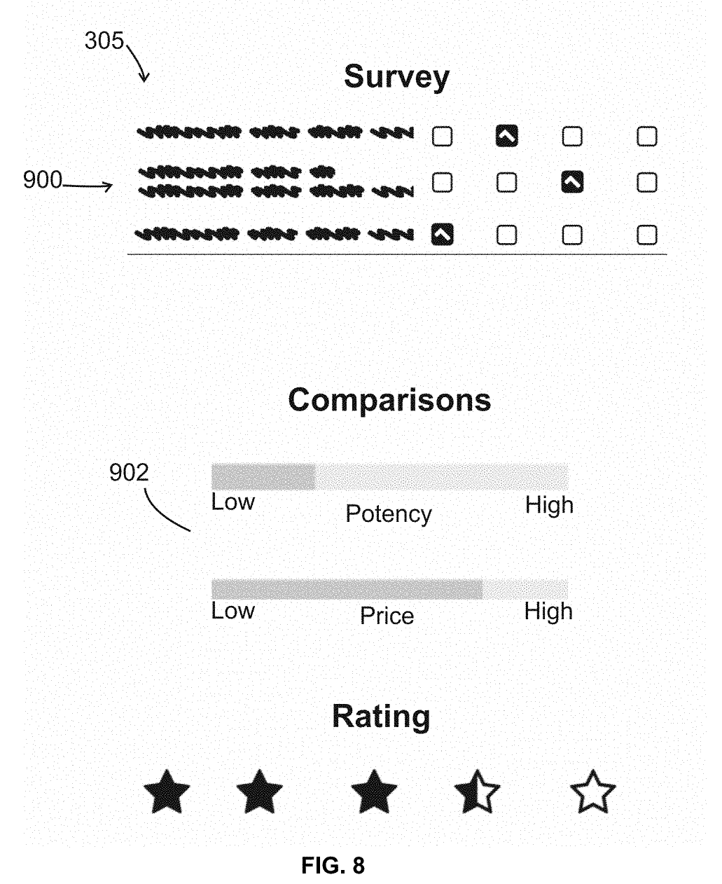

According to FIG. 8, the consumer undergo to the product review and rating section 305 to provide information pertaining to the product through a series of survey questions 900. The questions that appear in the survey will not be fixed and will constantly change to adapt for new information that the system requires. The system may also compile specific information about the user through this method, while in this section of the review platform the user may be asked to input information pertaining to personalized information that may assist the system with the creation of future reports/recommendation.

In this section the user may sometimes be prompted to enter feedback/answers through plain text written input. This is the only section of the review platform where the user may be prompted to type. The review platform will try to avoid the use of text if at all possible but in some cases, information can only be inputted through plain text.

In this section the user will be asked to make comparisons between various aspects of the product 902. The user will be providing with a rating system out of a range such as 5/10. The rating scale may be represented through the use of stars, thumbs up, cannabis leafs, etc. The user will be able to use the rating system to provide a general rating for the product that they have consumed.

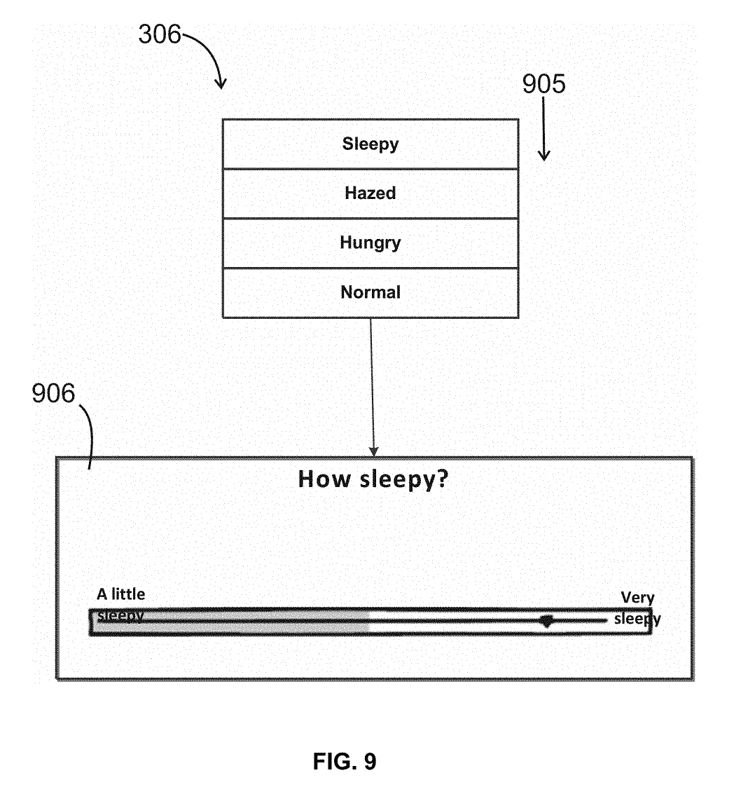

FIG. 9 illustrates a section to obtain feedback of the prolonged user experience 306. This section of the review platform will be optional for consumers to complete and will not be part of the initial review. The section will become available to users after a period of time has elapsed prior to the completion of the initial review.

The user will have the ability to select from a pre-set list of descriptive words, containing various effects such as (sleepy, hazed, hungry and normal) 905 that are associated with the product.

After the user has finished selecting all the corresponding effects from the pre-set list the system will pair the effects selected with a slider, dial, or gauge and ask the user to scale or gauge the effects being felt 906.

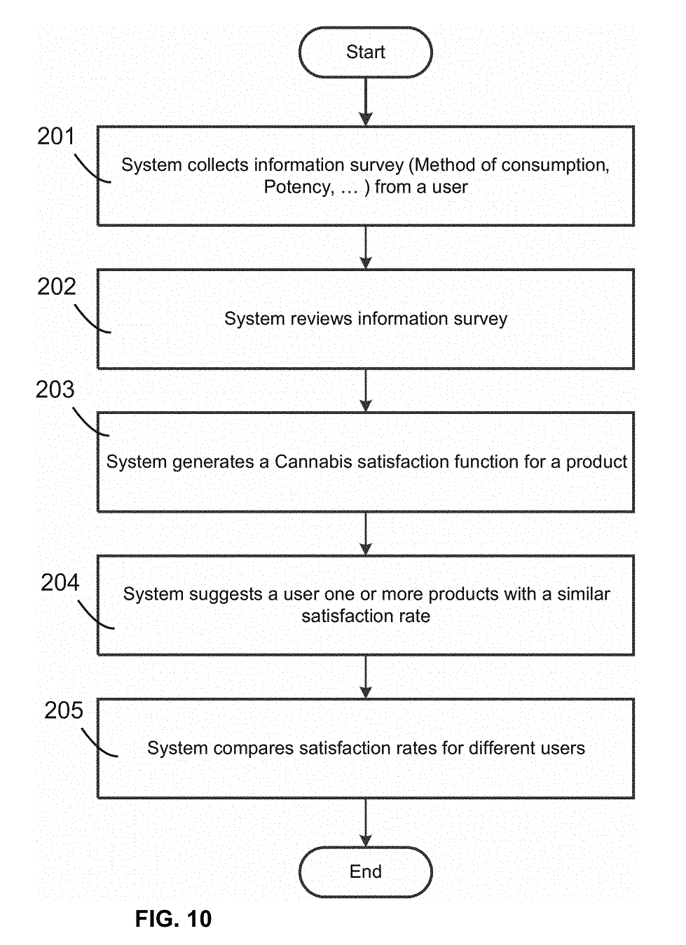

According to FIG. 10 the information of the surveys are then collected 201 and reviewed by the system 202 and uploaded into a sever and is used to generate a product satisfaction rate 203. The system uses the information of the review platform to suggest the user one or more products with a similar satisfaction rate 204. The system will also use benchmarks created from the information compiled from other users to generate product recommendations that the user may be interested in trying 205. The system creates a report containing information pertaining to the users past purchases and preferences.

The system will provide consumers with a unique review platform, the review platform the system implements will follow a specific template, and will only change slightly between reviews. Consumers will be able to utilize the review platform provided by the system so they may have an alternative to the conventional plain text typed reviews. The review platform provided by the system also tries to implement a level of gamification to the review, by providing graphical representations and moving parts.

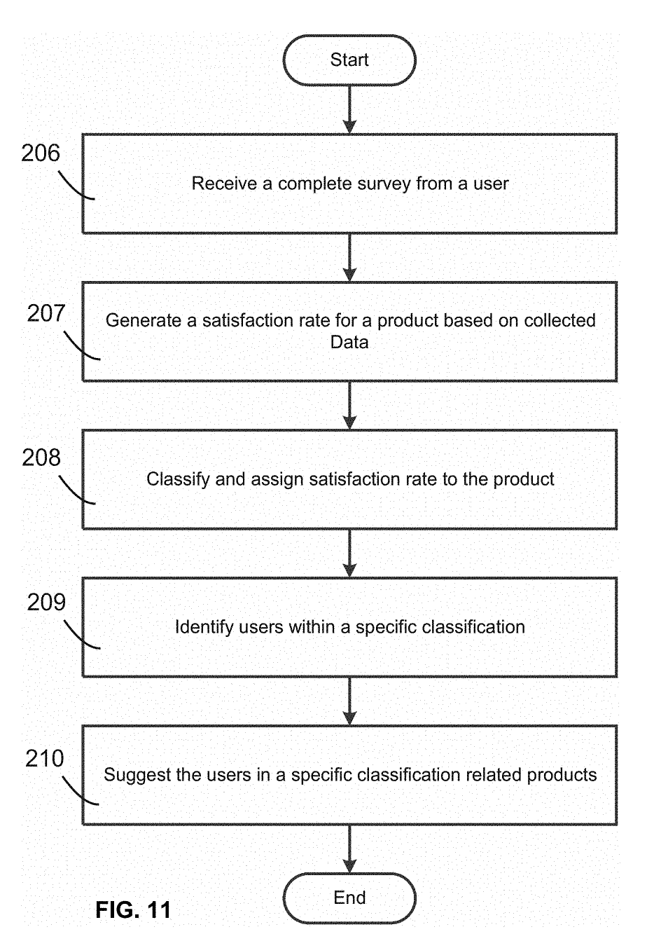

As shown in FIG. 11 the system receives a completed survey of all the navigation pages of the review platform 206 and generates a cannabis satisfaction rate for the product consumed by the consumer based on collected data 207. The satisfaction rate of the users is collected and a classified satisfaction rate is created for the product 208. The system identifies the users that are matched within the specified classification 209. This information will be stored in the users purchase log to for upcoming purchase recommendations 210.

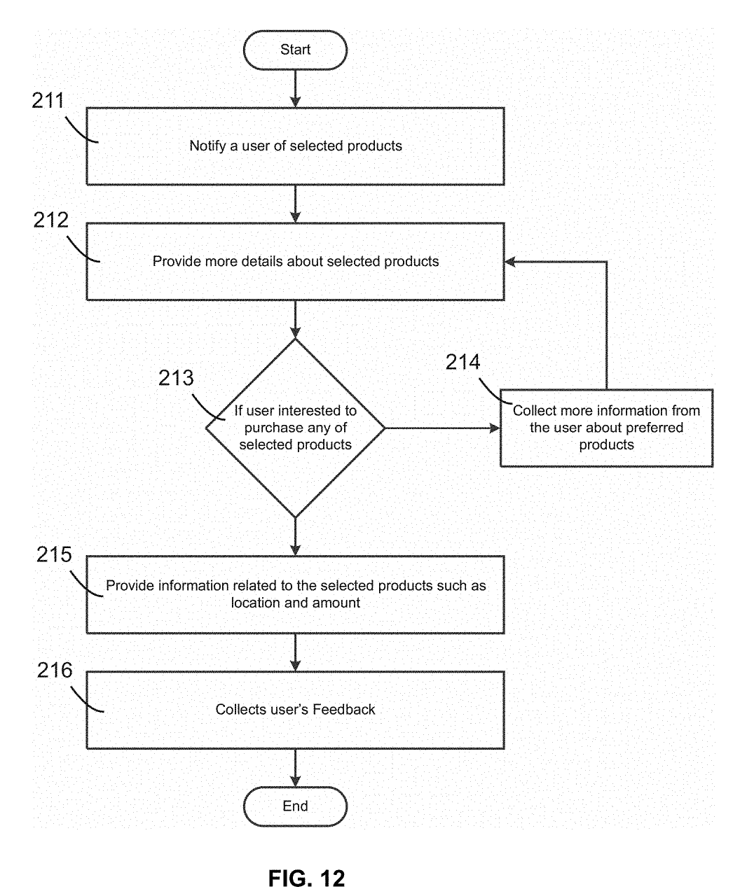

According to FIG. 12 the system notifies the consumer of the selected products 211 based on the reporting channels in the system. If the consumer is interested, the system provides more details about the selected products 212 and provides the information of the location of the cannabis stores and other related information of the product 215. If the user is interested to purchase any of the selected products 213, the system provides information related to the selected products such as location and amount of the product 215. If the consumer is not interested about the recommended product, system collects more information about the preferred product 214. The system collects user feedback after purchase and use the recommended product 216.

The system further includes consumer physical or digital membership card. The digital card include the features of; providing a membership account number; the users general information (i.e. name); the user with a QR scan code that contains the user's account information; the user with a Bar code containing the user's account information; the users with the capability to pair functions contained within the in-application membership card to their smart watch; the capability to use a NFC tag containing the user's account information (This feature only works if the user's phone has NFC capabilities); the capability to export the in-application membership card to the user's in-phone wallet (in-applicable), such as apple wallet.

The system further includes a physical membership card according to the present invention. The physical membership card contains a membership account number; the user's general information i.e. name; an embedded encrypted microchip containing the user's account information; a magnetic swipe strip containing the user's account information; an embedded NFC tag containing the user's account information. The Physical membership card will contain the feature, of requiring the card to be signed on the back, in-acknowledgement of the user's agreement to the terms and conditions with the use of the card.

The system will implement a social web feature for consumers. Users will be able to view other user's accounts. The system will include social discussion forums where users can use their accounts to discuss about products and other topics.

The system will implement an experience point based leveling system for accounts. Users will be awarded experience points, and experience based account level. Users will be able to gain experience points through the process of purchasing products, or providing product feedback. Experience points are used to show other consumers, the level of skill that is acquired using the system, and eventually will be used to provide consumers discounts on specified brands. The system enables consumers to develop a loyalty level with licenses cannabis clinics and manufactures by purchasing their products and providing reviews.

The system will provide retailers with an order assist feature, the feature can be utilized by bud tenders to help aid customers with their orders. Retailers will have the ability to market their products through the system. Products that are catalogued into the system for the purpose of purchase logging will be viewable by consumers in-system. Retailers will have the ability to market the products that are available for purchase in store.

What is claimed is:

1. A computer system for quantifying the satisfaction and experience of cannabis usage, comprising:
a) a consumer-account, which is accessible by a consumer and by an authorized-user;
b) a purchase log on said consumer-account to log and save an information about a purchased product by the consumer and a purchased location, whereby said information is logged by the authorized user;
c) a review platform comprising of a plurality of navigation pages to collect a plurality of usage-information comprising of: a method of usage, a potency, a product irritancy, a user experience, a product review comparison and rating, and a prolonged user experience, said review platform collecting from the consumer a satisfaction number for each said plurality of usage-information;
d) a total-satisfaction index is calculated for each said purchased product, wherein said total-satisfaction index represents an overall average satisfaction based on all said satisfaction numbers for said plurality of usage-information;
e) a sorting algorithm to aggregate said consumers having the same quantity of usage of said purchased product and the same method of consumption into a plurality of groups;
f) a ranking algorithm to rank said purchased product from said plurality of groups based on said total-satisfaction indices;
g) a collaborative filtering algorithm to find and recommend at least one product having the highest said total-satisfaction index;
h) a product catalogued inventory, wherein each product having information gathered from the review platform, and
i) an order-assisting-platform to provide recommendation for a client purchase,
whereby said customer may purchase said recommended product or any other product displayed on said product catalogue inventory.

2. The system of claim 1, wherein said authorized user is a dispensary, a vendor or a store.

3. The system of claim 1, further having a customer-report generating system to generate a customer-report pertaining to products a consumer may be interested in trying, wherein said collaborative filtering algorithm uses the information provided by all consumers and filters them according to the satisfaction numbers and the type of use provided by the consumer, whereby the consumer may use a new cannabis product that he or she has not used before.

4. The system of claim 1, further having a product-performance-report generating system to generate a product-performance-report pertaining to products purchased by consumers at a specified store, and using the purchase log information and consumer reports, wherein the information acquired for specified products is grouped across consumers using the same product, wherein the product-performance-report contains statistical and analytical representations of the performance of the products sold by a vendor, said performance-report is send to the store, the vendor, the local supplier, the grower or the manufacture,

5. The system of claim 4, wherein the system further having a business logic filter to create system generated recommendations for retailers pertaining restocking of a product that did well or poorly with the majority of the users.

6. The system of claim 1, further having a specialized-report generating system to generate a specialized-report for the domain experts, wherein said specialized-report uses the information from all consumers, stores and vendors across the system to determine behavioral patterns across users, wherein the system anonymizes consumer information for the creation of specialized-reports and for the statistical or analytical purposes, whereby the specialized-report is provided to the domain experts.

7. The method for quantifying the experience of cannabis usage, comprising:
a) receiving and logging a purchase information into a consumer account through an in-system purchase logger;
b) receiving a plurality of surveys competed by different consumers, each survey indicating a plurality of inquiries into consumer's experience, at least a portion of the inquiries requesting answers in a plurality of satisfaction indices;
c) receiving a plurality of surveys completed by different consumers;
d) performing a search on the answers to the inquiries to categorize the satisfaction numbers;
e) sorting consumers into groups based on profile and method of consumption;
f) generating a satisfaction index that approximates the satisfaction of a user;
g) selecting and recommending a cannabis-product selected based on the satisfaction index, and
h) uploading the purchase information into a sever and generating a report to the consumer via a mobile or an in system application by using benchmarks created from the information compiled from other users.

8. The method for acquiring feedback information in relation to cannabis and cannabis containing products of claim 7, wherein the system assist the consumer with the orders through an in system order assist feature using the information of their purchase log.

9. The method for acquiring feedback information in relation to cannabis and cannabis containing products of claim 7, wherein the authorized users will have access to reports via the in-system report channel that will be accessible via the system web based application and mobile based application.

10. The method for acquiring feedback information in relation to cannabis and cannabis containing products of claim 7, wherein the system implements experience based account to gain experience points to share.

11. The method for acquiring feedback information in relation to cannabis and cannabis containing products of claim 7, wherein the system provides a controlled entry and logging of cannabis strain to allow a consumer to keep track of the products they purchase, comprising:
a) registering a plurality of sellers into a system;
b) collecting and storing the cannabis product catalog of each seller in the system;
c) logging the strain of a cannabis product purchased by a consumer in a purchase log of consumer in a system by the seller of the product;
whereby the consumer is able to keep an organized log of all the strains and products purchased from various sellers that are in the system, and whereby the strain of the product can only be logged by the seller of the product and not by the user or others, thereby the information that is logged into a consumers account is accurate and corresponds with products acquired through purchases made by the consumer.

12. The method for acquiring feedback information in relation to cannabis and cannabis containing products of claim 7, further having a method of obtaining feedback from a consumer by allowing the consumer to provide feedback on a purchased and consumed product.

13. The method for acquiring feedback information in relation to cannabis and cannabis containing products of claim 7, wherein rating tools of the review platform being in the form of a slider, a gauge with an array of color, descriptive words, graphical representations and moving parts.
